(19) United States
(12) Patent Application Publication
(10) Pub. No.: US 2002/0129118 A1
(43) Pub. Date: Sep. 12, 2002

(54) Mobile remote printing systems

(76) Inventor: Darrel D. Cherry, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/804,607

(22) Filed: Mar. 12, 2001

(51) Int. Cl. G06F 15/16

(52) U.S. Cl. 709/217; 709/203

(57) ABSTRACT

Print systems for remotely printing intranet documents are provided. Typically, such an intranet is configured to store information corresponding to documents available for printing. Preferably, the print system includes a document retrieval system that is communicatively coupled with the intranet. The document retrieval system is configured to receive document reference information corresponding to a document to be printed and printer information corresponding to a network printer. In response to receiving the document reference information and printer information, the document retrieval system provides print information corresponding to the document to be printed to the network printer. So provided, the network printer, which is remote from the intranet, is enabled to print the document. Methods and computer-readable media also are provided.

### BACKGROUND OF THE INVENTION

1. Field of the Invention

The present invention generally relates to printing and, in particular, to systems and methods for facilitating remote printing of documents via a printer, which may be communicatively coupled to the Internet, for example.

2. Description of the Related Art

Oftentimes, a user may travel to a site that is remote from a location, e.g. an office, where the user has ready access to documents. For instance, a user may maintain an inventory of documents that are stored in an electronic format, with the documents being readily accessible by the user via an office computer network, such as an intranet, for example. Thus, when the user is at the office and desires a particular document, the user may access the document inventory, such as via a workstation, for example, and then print the document at a printer. Typically, that printer is communicatively coupled to the office intranet. However, when the user is not at the office, ready access to the documents available via the intranet typically is not provided.

By way of example, an intranet and its associated inventory of documents may not be externally accessible. In these intranet implementations, an enhanced degree of security may be provided for information maintained by the intranet as access to the information is necessarily restricted to those users communicating directly via the intranet. However, such a degree of security also may be overly restrictive to a user, who may be traveling, for example. For instance, if such a user requires a particular document that typically is available via the intranet, the user may not be able to obtain a copy of the document.

Therefore, there is a need for improved systems and methods that address these and/or other shortcomings of the prior art.

### SUMMARY OF THE INVENTION

Briefly described, the present invention relates to remote printing of documents. In this regard, embodiments of the invention may be construed as providing print systems for use with an intranet. Typically, such an intranet is configured to store information corresponding to documents available for printing. In a preferred embodiment, the print system includes a document retrieval system that is communicatively coupled with the intranet. The document retrieval system is configured to receive document reference information corresponding to a document to be printed and printer information corresponding to a network printer. In response to receiving the document reference information and printer information, the document retrieval system provides print information corresponding to the document to be printed to the network printer. Preferably, the print information is transmitted from the intranet to the network printer via the internet. So provided, the network printer, which is remote from the intranet, is enabled to print the document.

In some embodiments, the document reference information and printer information may be provided to the document retrieval system by a personal digital assistant (PDA). In some of these embodiments, the PDA is configured to establish a communications link with the network printer so as to enable collection of network printer information, as well as a communications link with the intranet so as to enable document reference information to be provided to the document retrieval system.

Other embodiments of the invention may be construed as providing methods for remotely printing a document. In this regard, a preferred method includes the steps of: (1) enabling retrieval of printer information corresponding to a network printer; (2) enabling identification of a document to be printed, print information corresponding to the document being stored at a location remote from the network printer; and (3) facilitating printing of the document at the network printer.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE SEVERAL VIEWS OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram of a preferred embodiment of the print system of the present invention.

FIG. 2 is a flowchart depicting preferred functionality of the print system of FIG. 1.

FIG. 3 is a schematic diagram of the print system of FIG. 1 showing detail of preferred embodiments of the document retrieval system and remote print request system.

FIG. 4 is a schematic diagram depicting a computer or processor-based system that may be utilized to implement the remote print request system of FIG. 3.

FIG. 5 is a flowchart depicting functionality of a preferred embodiment of the remote print request system of FIG. 4.

FIG. 6 is a schematic diagram depicting a computer or processor-based system that may be utilized to implement the document retrieval system of FIG. 3.

FIG. 7 is a flowchart depicting functionality of a preferred embodiment of the document retrieval system of FIG. 6.

### DESCRIPTION OF A PREFERRED EMBODIMENT

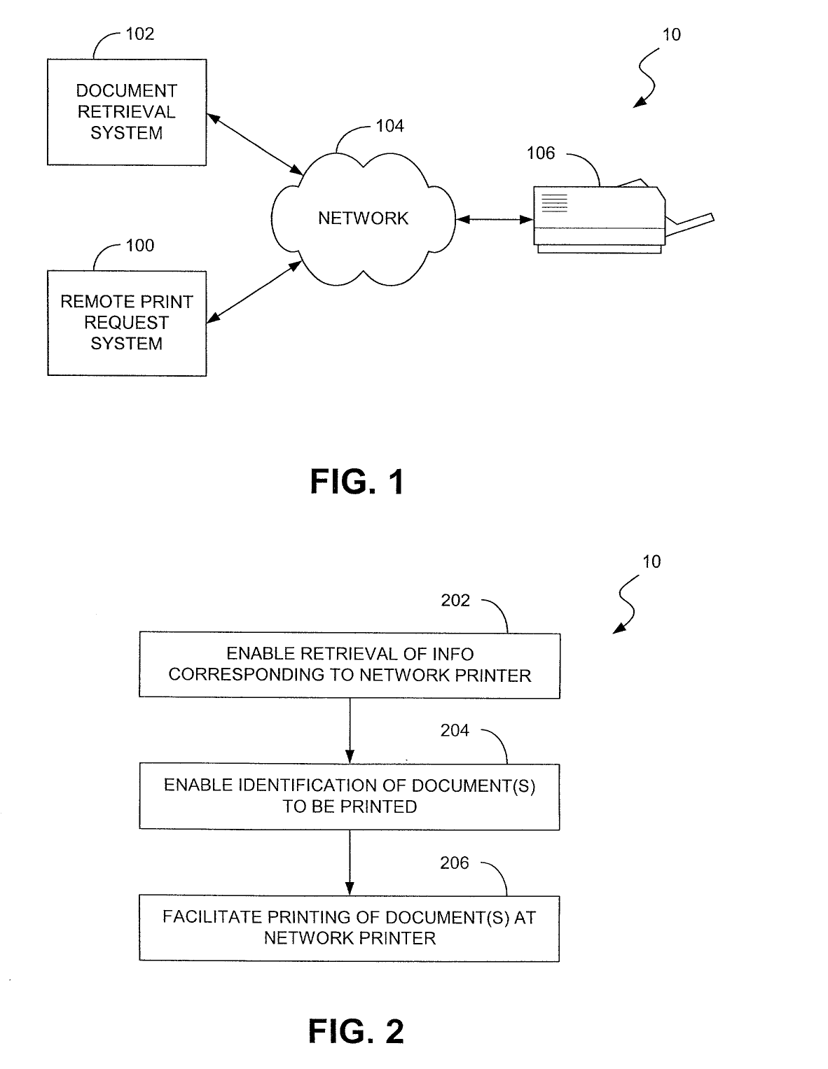

As shown in FIG. 1, a preferred embodiment of the print system 10 of the present invention incorporates a remote print request system 100 and a document retrieval system 102. Remote print request system 100 and document retrieval system 102 are configured to communicate so that information from the remote print request system may be provided to the document retrieval system and, in some embodiments, vice versa. By way of example, remote print request system 100 and document retrieval system 102 may communicate via a network 104. For instance, network 104 may be one or more of the Internet, a local area network, a wide area network, and a communications link(s), among others. So provided, remote print request system 100 and document retrieval system 102 may cooperate so as to facilitate remote printing of a document(s) at a printer, e.g., printer 106, which typically may not otherwise be associated with the document retrieval system.

Reference will now be made to the flowchart of FIG. 2, which depicts preferred functionality of print system 10. It should be noted that any process description(s) or block(s) presented in flowcharts herein may be construed, in some embodiments, as representing specific logical functions or steps in the process. Alternative implementations, however, also are provided wherein the functions or steps may be executed out of order from that shown or discussed, including substantially concurrently or in reverse order, depending on the functionality involved, as would be understood by those reasonably skilled in the art of the present invention.

As depicted in FIG. 2, preferred functionality of the print system or method 10 may be construed as beginning at block 202 where retrieval of information corresponding to a network printer is enabled. In block 204, identification of a document(s) to be printed is enabled. Thereafter, such as depicted in block 206, printing of a document(s) at the network printer is facilitated.

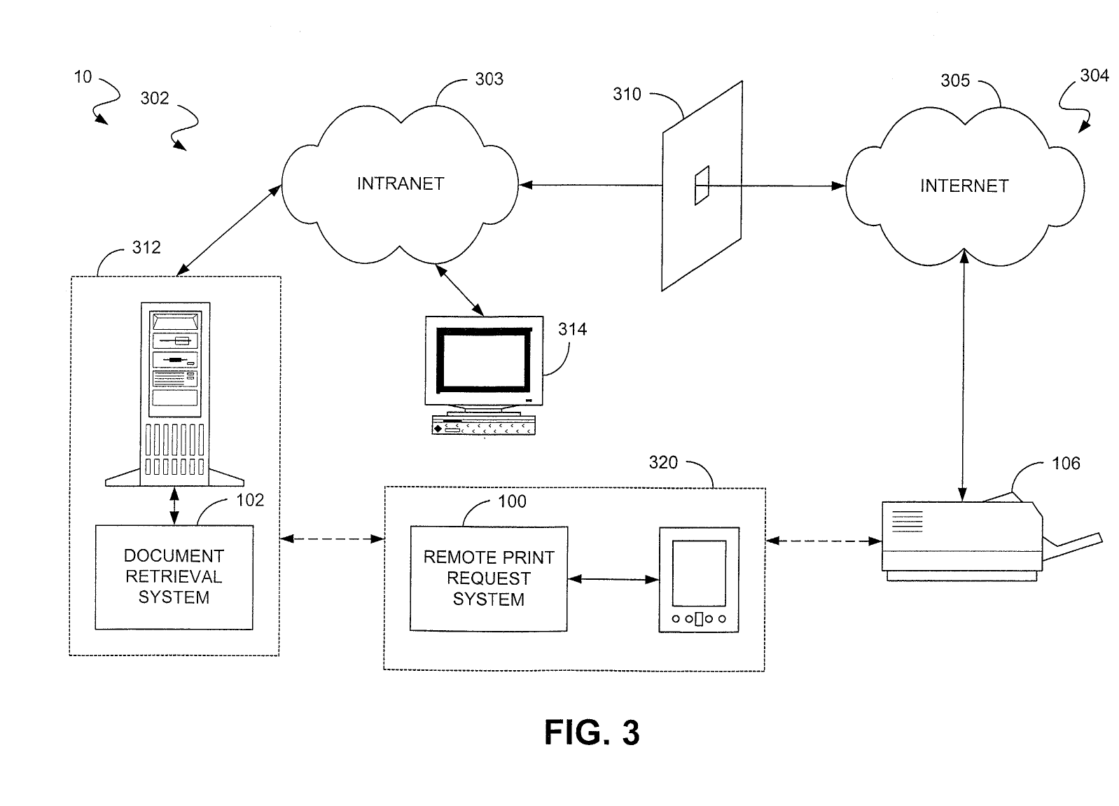

In FIG. 3, which depicts a preferred embodiment of print system 10, the print system includes an intranet environment 302 that is configured to intercommunicate with an Internet environment 304. More specifically, intranet environment 302 includes an intranet 303 that intercommunicates with the Internet 305 via in intermediately disposed firewall 310. As utilized herein, the term “intranet” refers to a network, which typically is based on TCP/IP protocols, that only may be used by those with authorization. Typically, an intranet is provided by an organization, e.g., a corporation, and is accessible only by the organization's members, and/or employees, for example.

As is known, firewall 310 is configured to restrict communications between intranet 303 and Internet 305 so as to provide a predetermined level of communications security. By way of example, firewall 310 may prevent various data from being intercommunicated between the intranet and the Internet. For instance, in some embodiments, the firewall may prevent a user from accessing an inventory of documents stored by the intranet and/or from requesting printing of a document(s) stored by the intranet at other than an intranet printer.

Intranet operability is facilitated by an intranet server(s) 312 so that various devices, such as workstation 314, for example, may store, access, and/or retrieve information from intranet server 312. Also depicted in FIG. 3 as being associated with Internet environment 304 is Internet printer 106, which is configured to communicate with Internet 305. Intercommunication between printer 106 and Internet 305 preferably is facilitated by printer 106 possessing an IP address that enables information to be directed to printer 106 via the Internet.

In the embodiment depicted in FIG. 3, remote print request system 100 is associated with a personal digital assistant (PDA) 320. As utilized herein, the term “personal digital assistant” refers to a portable device that is configured to facilitate a communications link, e.g., a wireless communications link, with another device possessing communications capabilities. Such a device also is adapted to store information and/or provide information to a user, such as via a display screen, for example. Representative examples of such a PDA may include a cell phone and a Palm Pilot™. As described in detail hereinafter, a user desiring to print an intranet document, e.g., a document stored on intranet 302, on a remote Internet printer may facilitate the desired printing by utilizing PDA 320. More specifically, the user may facilitate such printing by utilizing remote print request system 100.

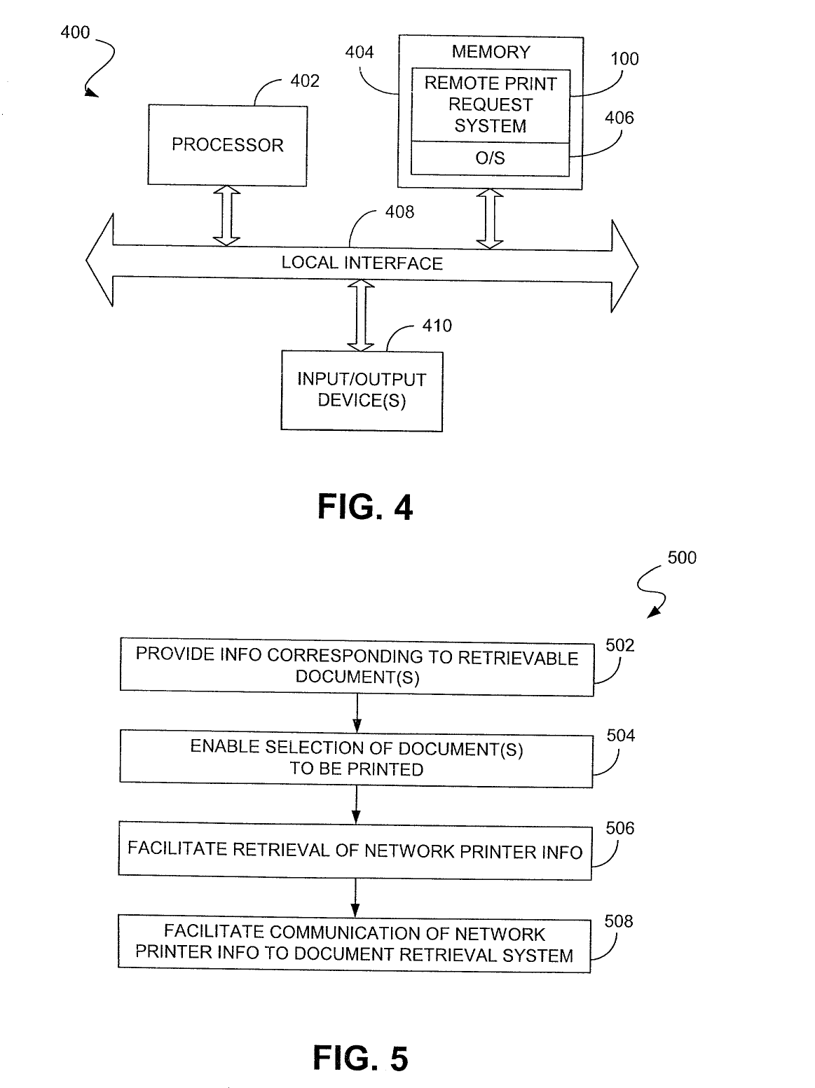

Embodiments of the remote print request system 100 of the invention can be implemented in software (e.g., firmware), hardware, or a combination thereof. In the currently contemplated best mode, the remote print request system is implemented in software, as an executable program, and is executed by a PDA; however, any other special or general purpose computer, such as a personal computer (PC; IBM-compatible, Apple-compatible, or otherwise), workstation, minicomputer, or mainframe computer, for example, could be utilized. An example of a general purpose computer that can implement the remote print request system of the present invention is shown in FIG. 4.

Generally, in terms of hardware architecture, as shown in FIG. 4, computer 400 includes a processor 402, memory 404, and one or more input and/or output (I/O) devices 410 that are communicatively coupled via a local interface 408. The local interface 408 can be, for example, but not limited to, one or more buses or other wired or wireless connections, as is known in the art. The local interface 408 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 402 is a hardware device for executing software that can be stored in memory 404. The processor 402 can be any custom made or commercially available processor, a central processing unit (CPU) or an auxiliary processor among several processors associated with the computer 400, a semiconductor-based microprocessor (in the form of a microchip), or a macroprocessor. Examples of commercially available microprocessors are as follows: an 80x86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 404 can include any one or combination of volatile memory elements (e.g., random access memory (RAM, such as DRAM, SRAM, etc.)) and nonvolatile memory elements (e.g., ROM, hard drive, tape, CDROM, etc.). Moreover, the memory 404 may incorporate electronic, magnetic, optical, and/or other types of storage media. Note that the memory 404 can have a distributed architecture, where various components are situated remote from one another, but can be accessed by the processor 402.

The software in memory 404 may include one or more separate programs, each of which comprises an ordered listing of executable instructions for implementing logical functions. In the example of FIG. 4, the software in the memory 404 includes the remote print request system 100 and a suitable operating system (O/S) 406. A nonexhaustive list of examples of commercially available operating systems 406 is as follows: a Windows operating system from Microsoft Corporation, U.S.A., a Netware operating system available from Novell, Inc., U.S.A., or a UNIX operating system, which is available for purchase from many vendors, such as Sun Microsystems, Inc., Hewlett-Packard Company, U.S.A., and AT&T Corporation, U.S.A. The operating system 406 essentially controls the execution of other computer programs, such as the remote print request system 100, and provides scheduling, input-output control, file and data management, memory management, and/or communication control and related services.

The I/O devices 410 may include input devices, for example, but not limited to, a keypad, touch screen, mouse, scanner, microphone, etc. Furthermore, the I/O devices 410 may also include output devices, for example, but not limited to, a printer, display, speaker, etc. Finally, the I/O devices 410 may further include devices that communicate both inputs and outputs, for instance but not limited to, a modulator/demodulator (modem; for accessing another device, system, or network), an RF transceiver, a bridge, a router, etc.

If the computer 400 is a PC, workstation, or the like, the software in the memory 404 may further include a basic input output system (BIOS) (omitted for simplicity). The BIOS is a set of essential software routines that initialize and test hardware at startup, start the O/S 406, and support the transfer of data among the hardware devices. The BIOS is stored in ROM so that the BIOS can be executed when the computer 400 is activated.

When the computer 400 is in operation, the processor 402 is configured to execute software stored within the memory 404, to communicate data to and from the memory 404, and to generally control operations of the computer 400 pursuant to the software. The remote print request system 100 and the O/S 406, in whole or in part, but typically the latter, are read by the processor 402, perhaps buffered within the processor 402, and then executed.

When the remote print request system 100 is implemented in software, as is shown in FIG. 4, it should be noted that the remote print request system 100 can be stored on any computer-readable medium for use by or in connection with any computer related system or method. In the context of this document, a computer-readable medium is an electronic, magnetic, optical, or other physical device or means that can contain or store a computer program for use by or in connection with a computer-related system or method. The remote print request system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the remote print request system 100 is implemented in hardware, the remote print request system can implemented with any or a combination of the following representative technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

As shown in FIG. 5, functionality of a preferred embodiment of the remote print request system or method 100 may be construed as beginning at block 502 where document reference information corresponding to retrievable documents is provided. By way of example, the remote print request system may be able to store document reference information corresponding to documents that typically are accessible via an intranet, e.g., intranet 302 (FIG. 3). Retrieval of the document reference information may be achieved in numerous manners, such as by direct connection to the intranet or via an intranet proxy agent, for example. Thus, a user may be provided with document reference information that may be reviewed by the user as desired via a PDA, for example.

In block 504, selection of a document(s) to be printed is enabled. By way of example, a user may review document reference information provided by the remote print request system and then select one or more of the documents associated with the document reference information for printing. In some embodiments, this may be facilitated by selecting a displayed icon corresponding to the document(s) to be printed. Thus, in embodiments incorporating the remote print request system in a PDA, the icons associated with the documents available for printing may be displayed via a display screen, for example, of the PDA. Selection of the document may be facilitated by actuating the icon by touch-actuation of the icon, for example.

In block 506, retrieval of network printer information is facilitated. For instance, network printer information may be obtained by communicatively coupling the PDA and, in particular, the remote print request system, with the printer that is to facilitate printing of the selected document(s). Communicative coupling may be accomplished with various methodologies, including, for example, infrared communication, physically coupling the PDA to a port of the printer, Ethernet, the Internet, etc. In other embodiments, network printer information required to facilitate the desired printing may be directly provided to the remote print request system, such as by the user manually inputting the IP address of the printer into the PDA. Other network printer information that may be utilized may include model number, print options, and printer capabilities, among others.

Proceeding to block 508, document reference information corresponding to the selected document(s) and network printer information corresponding to the selected network printer is communicated to the intranet that is associated with the document(s) to be printed, e.g., the intranet associated with document retrieval system 102 (FIG. 3). Communication with the document retrieval system may be facilitated via one or more connectivity methods including, for example, wireless, dial-up, virtual private network, etc., thereby enabling security of the intranet to be maintained.

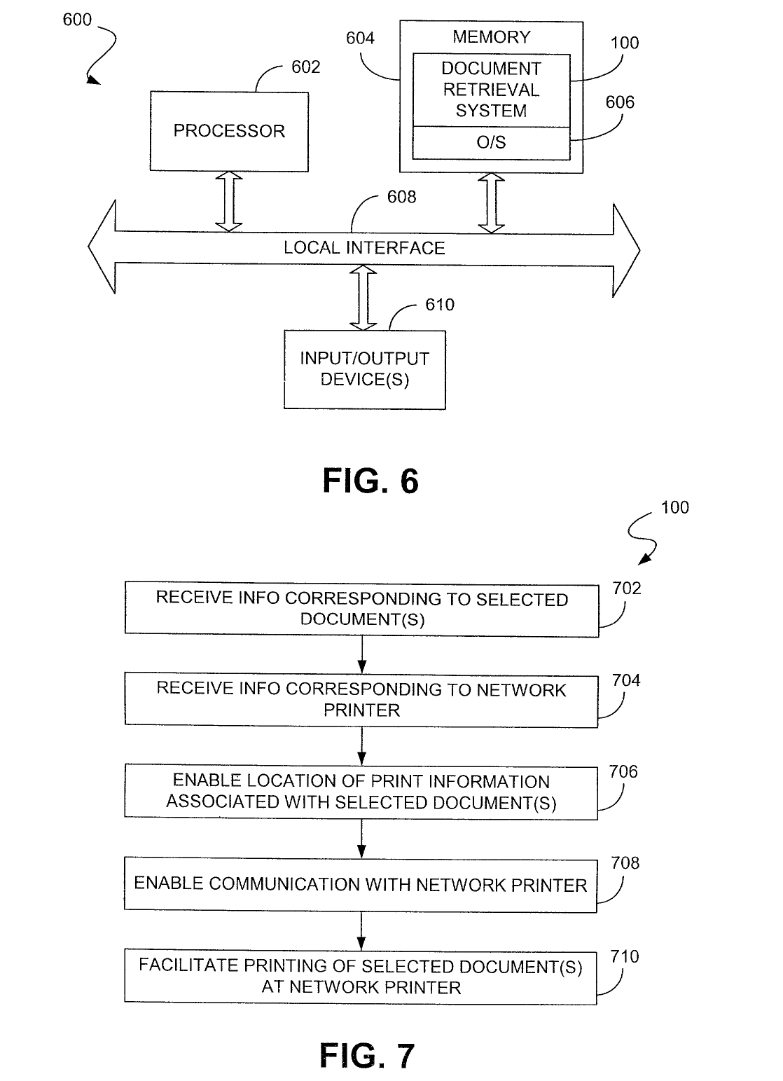

The document retrieval system of the invention also can be implemented in software (e.g., firmware), hardware, or a combination thereof. In the currently contemplated best mode, the document retrieval system is implemented in software, as an executable program, and is executed by a server, e.g., intranet server 312 (FIG. 3); however, any other special or general purpose computer, such as a personal computer (PC; IBM-compatible, Apple-compatible, or otherwise), workstation, minicomputer, or mainframe computer, for example, could be utilized. An example of a general purpose computer that can implement the remote print request system of the present invention is shown in FIG. 6. In FIG. 6, the document retrieval system is denoted by reference numeral 102.

Much like the computer 400 of FIG. 4, computer 600 includes a processor 602, memory 604, and one or more input and/or output (I/O) devices 610 that are communicatively coupled via a local interface 608. Software in the memory 604 includes the document retrieval system 102 and a suitable operating system (O/S) 606. In operation, the processor 602 is configured to execute software stored within the memory 604, to communicate data to and from the memory 604, and to generally control operations of the computer 600 pursuant to the software. When the document retrieval system 102 is implemented in software, as is shown in FIG. 6, it should be noted that the document retrieval system 102 can be stored on any computer-readable medium for use by or in connection with any computer-related system or method.

As depicted in FIG. 7, functionality of a preferred embodiment of the document retrieval system or method 102 may be construed as beginning at block 702 where document reference information corresponding to one or more selected documents to be printed is received. By way of example, the document reference information may be communicated to the document retrieval system by the remote print request system via wireless communication, for example. Additionally, such as depicted in block 704, network printer information corresponding to a printer for printing the selected document(s) is received.

In response to receiving document reference information, location of print information associated with the selected document(s) is enabled (block 706). Thereafter, such as depicted in block 708, communication with the network printer that is to perform printing of the selected document(s) is enabled. By way of example, communication of the document retrieval system with the printer may be facilitated by establishing a secure connection, such as via a proxy server, for example. In these embodiments, the connection may be facilitated by utilizing Hypertext Transfer Protocol (HTTP), for example.

In block 710, printing of the selected document(s) at the network printer is facilitated. For some print transactions, this may include rendering the print data for the specific printer and/or transmitting other information along with the print information so as to enable printing of the print information by the printer. In some embodiments, the document retrieval system may provide print information associated with the selected document(s) to the printer utilizing a secure connection protocol, such as Secure Sockets Layer (SSL), for example. So provided, the present invention may provide a secure printing transaction, while enabling a user to access and print documents remotely. More specifically, the present invention may enable printing of documents without having print information associated with those documents stored on their remote device (PDA) or, otherwise, directly accessible to the public via the Internet.

In some embodiments, an enhanced degree of security may be provided as compared to those embodiments described hereinbefore. In particular, some embodiments of the present invention may be configured to provide encrypted information to the network printer. In various ones of these embodiments, the information may be encrypted, such as at on the source machine, for example, and unencrypted at the destination printer. For instance, standard public/private and session key exchanges, among other encryption/decryption methodologies may be utilized. This would provide “end-to-end” security of a document.

Some embodiments of the present invention may utilize an authorization code for facilitating a print transaction. Such an authorization code may be provided to a user via the remote print request system. By way of example, when the remote print request system communicates information to the document retrieval system, the authorization code also may be communicated. The document retrieval system may utilize the authorization code to ensure that the user providing the document retrieval system with information is an authorized user. In some embodiments, the document retrieval system, which may be implemented via an intranet server as described hereinbefore, may interact with a proxy server for establishing a secure connection to the desired printer. Thus, in some embodiments, the proxy server may utilize the authorization code to ensure that the user is an authorized user.

In some embodiments, an authorization code may be provided so as to enable a one-time or limited-time usage of the print system of the present invention. Issuance of such an authorization code may be facilitated by the document retrieval system or other sub-system of the associated intranet. By way of example, the authorization code may be provided from the document retrieval system directly to the remote print request system while, in other embodiments, the document retrieval system may provide an authorization code that is to be communicated to a user via an intermediary. For instance, such an intermediary may be an operator who retrieves an authorization code and then communicates that code to the user. Thus, when the authorization code is communicated to the user, such as via phone, for example, the user may then provide the authorization code to the remote print request system for use by that system.

It should be noted that the present invention may be implemented with various security enhancements, such as requiring the use of one or more authorization codes to facilitate the aforementioned print system functionality. All such enhancements are considered well within the scope of the present invention.

The foregoing description has been presented for purposes of illustration and description. It is not intended to be exhaustive or to limit the invention to the precise forms disclosed. Modifications or variations are possible in light of the above teachings. The embodiment or embodiments discussed, however, were chosen and described to provide the best illustration of the principles of the invention and its practical application to thereby enable one of ordinary skill in the art to utilize the invention in various embodiments and with various modifications as are suited to the particular use contemplated. All such modifications and variations, are within the scope of the invention as determined by the appended claims when interpreted in accordance with the breadth to which they are fairly and legally entitled.

1. A method for remotely printing a document, said method comprising the steps of:
enabling retrieval of printer information corresponding to a network printer, the network printer being configured to communicatively couple with the Internet, the printer information including an IP address associated with the network printer;
enabling identification of a document to be printed, print information corresponding to the document being stored at a location remote from the network printer; and
facilitating printing of the document at the network printer by communicating information to the network printer via the Internet.

2. The method of claim 1, wherein the step of enabling identification of a document comprises the steps of:
communicatively coupling a personal digital assistant (PDA) to an intranet, the intranet providing access to print information corresponding to documents available for printing;
receiving document reference information corresponding to each document available for printing;
storing document reference information with the PDA; and
displaying, on the PDA, information corresponding to each document available for printing, the information being selectable such that selection of first information associated with a first document available for printing enables identification of the first document as a document to be printed at the network printer.

3. The method of claim 1, wherein the step of enabling identification of a document comprises the steps of:
receiving document reference information corresponding to each document available for printing; and
providing a user with information corresponding to each document available for printing.

4. The method of claim 1, wherein the step of enabling retrieval of printer information comprises the steps of:
communicatively coupling a personal digital assistant (PDA) to the network printer;
receiving printer information from the network printer; and
storing the printer information with the PDA.

5. The method of claim 1, wherein the step of facilitating printing of the document comprises the steps of:
communicatively coupling a personal digital assistant (PDA) to an intranet, the intranet providing access to print information corresponding to documents available for printing;
providing printer information and information corresponding to a document to be printed to the intranet;
retrieving print information corresponding to the document to be printed at the network printer; and
communicating the print information to the network printer such that the network printer prints the document.

6. The method of claim 4, wherein the step of receiving printer information comprises the step of receiving IP address information corresponding to the network printer.

7. The method of claim 5, wherein the step of communicating the print information comprises the step of communicating the print information to the network printer via the Internet such that the network printer prints the document.

8. The method of claim 5, further comprising the step of receiving an authorization code, and wherein the step of providing printer information comprises the step of providing the authorization code to the intranet such that the user may be identified as being authorized access to request printing of a document at the network printer.

9. The method of claim 8, wherein the step of receiving an authorization code comprises the step of storing the authorization code with the PDA.

10. A print system for use with an intranet, the intranet being configured to store information corresponding to documents available for printing, said print system comprising:
a document retrieval system communicatively coupled with an intranet, said document retrieval system being configured to receive document reference information corresponding to a document to be printed and printer information corresponding to a network printer and, in response thereto, provide print information corresponding to the document to be printed to the network printer via the Internet such that the network printer prints the document.

11. The print system of claim 10, further comprising:
a remote print request system configured to communicatively couple with said document retrieval system, said remote print request system being further configured to receive document reference information corresponding to documents available for printing via the intranet, enable selection by a user of a document to be printed, and provide information corresponding to a document selected to be printed to said document retrieval system.

12. The print system of claim 11, wherein said remote print request system is configured to communicatively couple with a network printer such that said remote print request system is able to receive printer information corresponding to the network printer and provide said document retrieval system with the printer information.

13. The print system of claim 1 1, wherein said remote print request system is implemented in a personal digital assistant.

14. The print system of claim 11, wherein said document retrieval system is configured to provide said remote print request system with an authorization code, said remote print request system being configured to provide said authorization code to said document retrieval system when providing information to said document retrieval system for facilitating printing of a document at the network printer.

15. The print system of claim 11, wherein said remote print request system comprises means for communicatively coupling with a network printer such that said remote print request system is able to receive printer information corresponding to the network printer.

16. The print system of claim 11, wherein said document retrieval system comprises means for retrieving print information corresponding to a document to be printed in response to receiving document reference information from said remote print request system.

17. A computer readable medium for facilitating remote printing of a document to a network printer, the network printer being configured to communicatively couple with the Internet, said computer readable medium comprising:
logic configured to enable identification of a document to be printed, print information corresponding to the document to be printed being stored at a location remote from the network printer;
logic configured to receive printer information corresponding to the network printer, the printer information including an IP address associated with the network printer; and
logic configured to provide the printer information and information corresponding to the document to be printed to a location remote from the network printer such that printing of the document by the network printer is facilitated, at least in part, by communicating information from the remote location to the network printer via the Internet.

18. The computer readable medium of claim 17, wherein the logic configured to enable identification of a document to be printed comprises:
logic configured to receive document reference information corresponding to each document available for printing; and
logic configured to display information corresponding to each document available for printing to a user.

19. A computer readable medium for facilitating remote printing of a document to a network printer, the network printer being configured to communicatively couple with the Internet, said computer readable medium comprising:
logic configured to store print information corresponding to documents available for printing at a network printer;
logic configured to retrieve print information corresponding to a document to be printed at the network printer; and
logic configured to enable communication, via the Internet, of information corresponding to the document to be printed to the network printer such that printing of the document by the network printer is facilitated.

20. The computer readable medium of claim 19, wherein the logic configured to retrieve print information comprises:
logic configured to receive information corresponding to a document to be printed;
logic configured to store an authorization code corresponding to a user;
logic configured to receive an authorization code from the user;
logic configured to evaluate the authorization code such that the user may be identified as being authorized access to request printing of a document at the network printer; and
wherein the logic configured to enable communication facilitates communication of the information corresponding to the document to be printed to the network printer in response to the user being identified as being authorized access to request printing of the document at the network printer.
